(19) United States
(12) Patent Application Publication
(10) Pub. No.: US 2021/0073591 A1
(43) Pub. Date: Mar. 11, 2021

(54) ROBUSTNESS ESTIMATION METHOD, DATA PROCESSING METHOD, AND INFORMATION PROCESSING APPARATUS

(71) Applicant: FUJITSU LIMITED, Kawasaki-shi (JP)

(72) Inventors: Chaoliang ZHONG, Beijing (CN); Ziqiang SHI, Beijing (CN); Wensheng XIA, Beijing (CN); Jun SUN, Beijing (CN)

(73) Assignee: FUJITSU LIMITED, Kawasaki-shi (JP)

(21) Appl. No.: 17/012,357

(22) Filed: Sep. 4, 2020

(30) Foreign Application Priority Data
Sep. 6, 2019 (CN) 201910842524.8

(51) Int. Cl. G06K 9/62; G06N 3/08

(52) U.S. Cl. CPC G06K 9/6262; G06K 9/6268; G06N 3/08; G06K 9/6232; G06K 9/6261; G06K 9/6215

(57) ABSTRACT

A robustness estimation method, a data processing method, and an information processing apparatus are provided. The method for estimating robustness a classification model obtained in advance through training based on a training data set, includes: for each training sample in the training data set, determining a target sample in a target data set that has a sample similarity with a respective training sample that is within a predetermined threshold range, and calculating a classification similarity between a classification result of the classification model with respect to the respective training sample and a classification result of the classification model with respect to the determined respective target sample; and determining, based on classification similarities between classification results of respective training samples in the training data set and classification results of corresponding target samples in the target data set, classification robustness of the classification model with respect to the target data set.

The application claims the priority to Chinese Patent Application No. 201910842524.8, titled “ROBUSTNESS ESTIMATION METHOD, DATA PROCESSING METHOD, AND INFORMATION PROCESSING APPARATUS”, filed on Sep. 6, 2019 with the China National Intellectual Property Administration, which is incorporated herein by reference in its entirety.

### TECHNICAL FIELD

The present disclosure generally relates to the field of machine learning, and in particular to a robustness estimation method for estimating robustness of a classification model which is obtained through training, an information processing device for performing the robustness estimation method, and a data processing method for using a classification model selected with the robustness estimation method.

### BACKGROUND

With the development of machine learning, classification models obtained based on machine learning receive more and more attention, and are increasingly applied in various fields such as image processing, text processing, and time-series data processing.

For various models, including classification models, obtained through training, there is a case that a training data set for training a model and a target data set to which the model is finally applied are not independent and identically distribute (IID), that is, there is a bias between the training data set and the target data set. Therefore, there may be a problem that the classification model has good performance with respect to the training data set and has poor performance or poor robustness with respect to the target data set. If the model is applied to a target data set of a real scenario, processing performance of the model may be greatly decreased. Accordingly, it is desired to know in advance performance or robustness of a classification model with respect to a target data set.

However, since labels of samples in the target data set are unknown, the robustness of the classification model with respect to the target data set cannot be directly calculated. Therefore, it is desired to provide a method for estimating robustness of a classification model with respect to a target data set.

### SUMMARY

A brief summary of the present disclosure is given below to provide basic understanding of the present disclosure. It should be understood that the summary is not an exhaustive summary of the present disclosure. It is not intended to define the key part or important part of the present disclosure, or to limit the scope of the present disclosure. The purpose is only to provide some concepts in a simplified form as a preface of subsequent detailed descriptions.

According to an aspect of the present disclosure, a robustness estimation method is provided, for estimating robustness of a classification model which is obtained in advance through training based on a training data set. The robustness estimation method includes: for each training sample in the training data set, determining a respective target sample in a target data set that has a sample similarity with a respective training sample that is within a predetermined threshold range (that is, meets a requirement associated with a predetermined threshold), and calculating a classification similarity between a classification result of the classification model with respect to the respective training sample and a classification result of the classification model with respect to the determined respective target sample.

The robustness estimation method according to an aspect of the present disclosure includes: determining, based on classification similarities between classification results of respective training samples in the training data set and classification results of corresponding target samples in the target data set, classification robustness of the classification model with respect to the target data set.

According to another aspect of the present disclosure, a data processing method is further provided. The data processing method includes: inputting a target sample into a classification model, and classifying the target sample with the classification model, where the classification model is obtained in advance through training with a training data set, and where classification robustness of the classification model with respect to a target data set to which the target sample belongs exceeds a predetermined robustness threshold, the classification robustness being estimated by a robustness estimation method according to an embodiment of the present disclosure.

According to another aspect of the present disclosure, an information processing apparatus is further provided. The information processing apparatus includes a processor. The processor is configured to: for each training sample in a training data set, determine a respective target sample in a target data set that has a sample similarity with a respective training sample that is within a predetermined threshold range, and calculate a classification similarity between a classification result of a classification model with respect to the respective training sample and a classification result of the classification model with respect to the determined respective target sample, where the classification model is obtained in advance through training based on the training data set.

According to another aspect of the present disclosure, the processor of the information processing apparatus is configured to: determine, based on classification similarities between classification results of respective training samples in the training data set and classification results of corresponding target samples in the target data set, classification robustness of the classification model with respect to the target data set.

According to another aspect of the present disclosure, a program is further provided. The program causes a computer to perform the robustness estimation method as described above.

According to another aspect of the present disclosure, a storage medium is further provided. The storage medium stores machine-readable instruction codes, which, when being read and executed by a machine, causes the machine to perform the robustness estimation method as described above.

These and other advantages of the present disclosure will be more apparent from the following detailed description of preferred embodiments of the present disclosure in conjunction with the accompanying drawings.

### BRIEF DESCRIPTION OF THE DRAWINGS

The present disclosure may be better understood by referring to the following description given in conjunction with the accompanying drawings in which same or similar reference numerals are used throughout the drawings to refer to the same or like parts. The accompanying drawings, together with the following detailed description, are included in this specification and form a part of this specification, and are used to further illustrate preferred embodiments of the present disclosure and to explain the principles and advantages of the present disclosure. In the drawings:

FIG. 1 is a flow chart schematically showing an example flow of a robustness estimation method according to an embodiment of the present disclosure;

FIG. 2 is an explanatory diagram for explaining an example process performed in operation S101 for calculating a classification similarity in the robustness estimation method shown in FIG. 1;

FIG. 3 is a flow chart schematically showing an example flow of a robustness estimation method according to another embodiment of the present disclosure;

FIG. 4 is a flow chart schematically showing an example flow of a robustness estimation method according to another embodiment of the present disclosure;

FIG. 5 is a flow chart schematically showing an example process performed in operation S400 for determining reference robustness in the robustness estimation method shown in FIG. 4;

FIG. 6 is an example table for explaining accuracy of a robustness estimation method according to an embodiment of the present disclosure;

FIG. 7 is a schematic block diagram schematically showing an example structure of a robustness estimation apparatus according to an embodiment of the present disclosure;

FIG. 8 is a schematic block diagram schematically showing an example structure of a robustness estimation apparatus according to another embodiment of the present disclosure;

FIG. 9 is a schematic block diagram schematically showing an example structure of a robustness estimation apparatus according to another embodiment of the present disclosure;

FIG. 10 is a flow chart schematically showing an example flow of using a classification model having good robustness determined with a robustness estimation method according to an embodiment of the present disclosure to perform data processing; and

FIG. 11 is a structural diagram showing an exemplary hardware configuration for implementing a robustness estimation method, a robustness estimation apparatus and an information processing apparatus according to embodiments of the present disclosure.

### DETAILED DESCRIPTION OF THE EMBODIMENTS

Exemplary embodiments of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a business, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing operations (steps) closely related to the solution according to the present disclosure are illustrated in the drawings, and other details having little relationship to the present disclosure are omitted.

In view of the need of obtaining in advance the robustness of the classification model with respect to the target data set, a robustness estimation method is provided according to one of the objectives of the present disclosure, for estimating the robustness of the classification model with respect to the target data set without obtaining labels of target samples in the target data set.

According to the aspects of the present disclosure, at least one or more of the following benefits can be obtained. Based on classification similarities between classification results of the classification model with respect to the training samples in the training data set and classification results of the classification model with respect to the corresponding (or similar) target samples in the target data set, classification robustness of the classification model with respect to the target data set can be estimated without obtaining the labels of the target samples in the target data set. In addition, with the robustness estimation method according to the embodiment of the present disclosure, a classification model having good robustness with respect to the target data set can be selected from multiple candidate classification models that are trained in advance, and then this classification model can be applied to subsequent data processing to improve the performance of subsequent processing.

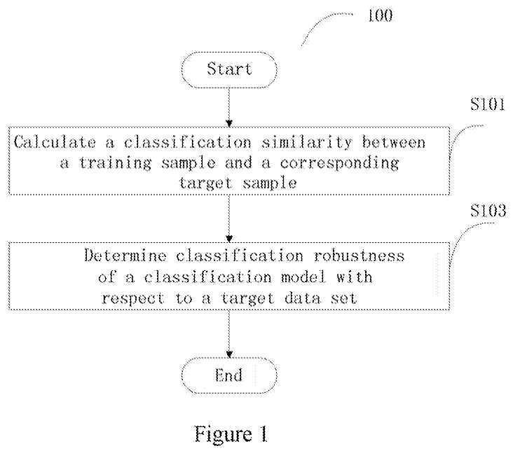

A robustness estimation method is provided according to an aspect of the present disclosure. FIG. 1 is a flow chart schematically showing an example flow of a robustness estimation method 100 according to an embodiment of the present disclosure. The method is used for estimating robustness of a classification model which is obtained in advance through training based on a training data set.

As shown in FIG. 1, the robustness estimation method 100 includes operations S101 and S103. In operation S101, for each training sample in the training data set, a target sample in a target data set whose sample similarity with the training sample is within a predetermined threshold range (that is, a target sample whose sample similarity with the training sample meets a requirement associated with a predetermined threshold, and such a target sample may be referred to as a corresponding or similar target sample of the training sample herein) is determined, and a classification similarity between a classification result of the classification model with respect to the training sample and a classification result of the classification model with respect to the determined target sample is calculated. In operation S103, based on classification similarities between classification results of respective training samples in the training data set and classification results of corresponding target samples in the target data set, classification robustness of the classification model with respect to the target data set is determined.

With the robustness estimation method according to the embodiment, based on classification similarities between classification results of the classification model with respect to the training samples in the training data set and classification results of the classification model with respect to the corresponding (or similar) target samples in the target data set, classification robustness of the classification model with respect to the target data set can be estimated without obtaining the labels of the target samples in the target data set. For example, if classification results of the classification model with respect to the training samples and classification results of the classification model with respect to the corresponding (or similar) target samples are similar or consistent with each other, it is determined that the classification model is robust with respect to the target data set.

As an example, both the training data set and the target data set of the classification model may include image data samples or time-series data samples.

For example, the classification model involved in the robustness estimation method according to the embodiment of the present disclosure may be a classification model used for various image data, e.g. classification models used for various image classification applications, such as semantic segmentation, handwritten character recognition, traffic sign recognition, or the like. Such a classification model may be in various forms suitable for image data classification, such as a model based on a convolutional neural network (CNN). In addition, the classification model may be a classification model used for various time-series data, such as a classification model used for weather forecast based on previous weather data.

Such a classification model may be in various forms suitable for time-series data classification, such as a model based on a recurrent neural network (RNN).

Those skilled in the art should understand that the application scenarios of the classification model and the specific types or forms of the classification model and the data processed by the classification model in the robustness estimation method according to the embodiment of the present disclosure are not limited, as long as the classification model is obtained in advance through training based on the training data set and is to be applied to the target data set.

For the convenience of description, specific process according to the embodiment of the present disclosure is described in conjunction with a specific example of a classification model C. In the example, based on a training data set D_{S} including multiple training (image) samples x, a classification model C is obtained in advance through training, for classifying the image samples into one of predetermined N categories (N is a natural number greater than 1). The classification model C is to be applied to a target data set D_{T} including target (image) samples y, and the classification model C is based on a convolutional neural network (CNN). Based on the embodiment of the present disclosure provided in conjunction with the example, those skilled in the art may appropriately apply the embodiment of the present disclosure to data and/or model of other forms, and details are not described herein.

Example processes performed in respective operations in the example flow of the robustness estimation method 100 according to the embodiment are described with reference to FIG. 1 and in conjunction with the example of the classification model C. First, an example process in operation S101 for calculating a classification similarity is described in conjunction with the example of the classification model C.

In operation S101, for each training sample x in the training data set D_{S}, sample similarities between respective target samples y in the target data set D_{T} and the training sample x are calculated, to determine a corresponding or similar target sample whose sample similarity with the training sample x meets a requirement associated with a predetermined threshold.

In an embodiment, a similarity between a feature extracted from a training sample and a feature extracted from a target sample may be used to characterize a sample similarity between the training sample and the target sample.

For example, a feature similarity between a feature f(x) extracted with the classification model C from the training sample x and a feature f(y) extracted with the classification model C from the target sample y may be calculated as a sample similarity between the training sample x and the target sample y. Herein, f( ) represents a function for extracting a feature with the classification model C from an input sample. In the example where the classification model C is a CNN model for image processing, f( ) may represent a function for extracting an output of a fully connected layer immediately before a Softmax activation function in the CNN model as a feature in a form of a vector extracted from the input sample. Those skilled in the art should understand that, for different applications and/or data, outputs of different layers of the CNN model may be extracted as appropriate features, which is not particularly limited in the present disclosure.

For the features f(x) and f(y) respectively extracted from the training sample x and the target sample y, an L1 norm distance, an Euclidean distance, a cosine distance, or the like, between the feature f(x) and the feature f(y) may be calculated, to characterize the feature similarity between the feature f(x) and the feature f(y), thereby characterizing the corresponding sample similarity. It should be noted that, as understood by those skilled in the art, the expression of “calculating/determining a similarity” includes “calculating/determining an index characterizing the similarity” herein, and a similarity may be determined by calculating an index (such as the L1 norm distance) characterizing the similarity in the following description, which will not be described in detail.

As an example, the L1 norm distance D(x, y) between the feature f(x) of the training sample x and the feature f(y) of the target sample y may be calculated according to the following equation (1):

D(x,y)=∥f(x)−f(y)∥ (1)

In equation (1), a calculation result of the L1 norm distance D(x, y) ranges from 0 and 1, and a small calculation result of the D(x, y) indicates a large feature similarity between the feature f(x) and the feature f(y), that is, a large sample similarity between the training sample x and the target sample y.

After calculating L1 norm distances D(x, y) between the features of respective target samples y in the target data set D_{T} and the feature of the given training sample x to characterize the sample similarities, target samples y whose sample similarities are within a predetermined threshold range (that is, whose L1 norm distances D(x, y) are less than a predetermined distance threshold) may be determined. For example, target samples y which satisfy the following equation (2) may be determined. L1 norm distances D (x, y) between the features of the these target samples γ and the feature of the training sample x are less than a predetermined distance threshold δ, and these target samples y are taken as “corresponding” or “similar” target samples of the training sample x.

D(x,y)≤δ (2)

The distance threshold δ may be appropriately determined according to various design factors such as processing load and application requirements.

For example, a distance threshold may be determined based on a corresponding average intra-class distance (which is used for characterizing an average intra-class similarity among training samples) among training samples of N categories included in the training data set D_{S}. Specifically, a L1 norm distance δ^{p} between each pair of samples in the same category in the training data set D_{S} may be determined, where p=1, 2, . . . P, and P represents the total number of pairs of samples in the same category for each category in the training data set D_{S}. Then, an average intra-class distance of the entire training data set D_{S} may be calculated based on L1 norm distances δ^{p}, each of which is between each pair of samples in the same-category, of all categories as follows:

$$δ = \frac{{Σ}_{p = 1}^{P} {δ}^{p}}{P}$$

The δ calculated in the above way may be taken as the distance threshold for characterizing a similarity threshold.

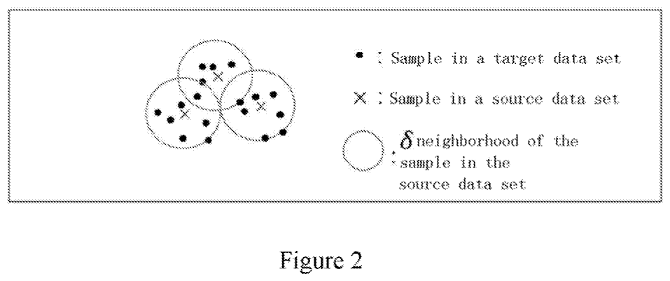

Referring to FIG. 2, equation (2) may be better understood. FIG. 2 is an explanatory diagram for explaining an example process performed in operation S101 for calculating a classification similarity in the robustness estimation method shown in FIG. 1. FIG. 2 schematically shows training samples and target samples in a feature space satisfying equation (2). In FIG. 2, each symbol x represents a training sample in the feature space, each symbol • represents a target sample in the feature space, each hollow circle having a center of a symbol x and a radius of δ represents a neighborhood of the corresponding training sample in the feature space, and each symbol • falling into the hollow circle represents a target sample whose similarity with the training sample meets a requirement associated with a predetermined threshold (in the example, the requirement associated with a predetermined threshold is that the L1 norm distance D(x, y) between features is within the distance threshold δ).

In this way, for each training sample, a corresponding or similar target sample in the target data set can be determined, to estimate classification robustness of the classification model with respect to the target data set based on a classification similarity between a classification result of each training sample and a classification result of the corresponding or similar target sample.

The above example is described with a situation that a uniform distance threshold (corresponding to a uniform similarity threshold) is used for respective training samples in the training data set to determine a corresponding target sample in the target data set.

In an embodiment, in a process of determining the target sample whose similarity with the training sample is within a predetermined threshold range (or meeting a requirement associated with a predetermined threshold), a similarity threshold associated with a category to which the training sample belongs may be taken as the corresponding predetermined threshold. For example, a similarity threshold associated with a category to which a training sample belongs may include an average sample similarity among training samples in the training data set that belong to the category.

In such a case, for training samples of an i-th category (i=1, 2, . . . , N) in the training data set D_{S}, intra-class average distances δᵢ of all training samples in the category (that is, an average value of L1 norm distances between features of each pair of training samples in the training samples in the i-th category, i=1, 2, . . . N) may be taken as a distance threshold δᵢ for the category in this example. Moreover, a target sample y satisfying the following equation (2′), instead of equation (2), in the target data set D_{T} is determined as a corresponding target sample of a given training sample x in the i-th category:

D(x,y)≤δᵢ (2′)

It is found by the inventor(s) that the intra-class average distances δᵢ between the training samples in each category may be different from each other. Further, the intra-class average distances δᵢ are small if the training samples in a category are tightly distributed in a feature space, and the intra-class average distances δᵢ are large if the training samples in the category are loosely distributed in the feature space. Therefore, the intra-class average distance of the training samples in each category are taken as the distance threshold of the category, which may facilitate determination of appropriate neighborhood of the training samples in the category in the feature space, thereby accurately determining similar or corresponding target samples in the target data set for the training samples in each category.

After each training sample x and corresponding target samples y are determined based on the above equations (1) and (2) or (2′), a classification similarity S(x, y) between a classification result c(x) of the classification model C with respect to the training sample x and a classification result c(y) of the classification model C with respect to each of the determined target samples y may be calculated in operation S101 according to, for example, the following equation (3):

S(x,y)=1−∥c(x)−c(y)∥ (3)

In equation (3), c (x) and c (y) respectively represent the classification results of the classification model C with respect to the training sample x and the target sample y. The classification result may be in a form of an N-dimensional vector, which corresponds to N categories outputted by the classification model C, where only a dimension corresponding to a classification result of the classification model C with respect to an inputted sample is set to 1, and the other dimensions are set to 0. ∥c(x)−c(y)∥ represents an L1 norm distance between the classification results c(x) and c(y), and has a value of 0 or 1. The classification similarity S(x, y) is 1 if the classification results satisfy a condition of c(x)=c(y), and the classification similarity S(x, y) is 0 if the classification results do not satisfy the condition of c(x)=c(y). It should be noted that equation (3) only shows an example calculation way, and those skilled in the art may calculate the classification similarity between the classification results in other way of similarity calculation. For example, if the classification similarity is calculated in another form, classification similarity S(x, y) may be set to range from 0 to 1, wherein S(x, y) is set to be 1 if the classification results satisfy the condition of c(x)=c(y), and S(x, y) is set to be less than 1 if the classification results do not satisfy the condition of c(x)=c(y), which is not repeated here.

After classification similarities between classification results of respective training samples x and classification results of corresponding target samples y are obtained in operation S101, for example, in a form of equation (3), the example processing shown in FIG. 1 may proceed to operation S103.

In operation S103, based on classification similarities S(x,y)=1−∥c(x)−c(y)∥ between classification results c(x) of respective training samples x in the training data set D_{S} and classification results c(y) of the corresponding target samples y in the target data set D_{T}, classification robustness R¹(C,T) of the classification model C with respect to the target data set D_{T} is determined, for example, according to the following equation (4):

R¹(C,T)=E_{x˜D}_{_{S}}_{,y˜D}_{_{T}}_{,∥f(x)-f(y)∥≤δ}[1−∥C(x)−c(y)∥] (4)

Equation (4) indicates that a classification similarity 1−∥c(x)−c(y)∥ between a classification result of the classification model with respect to the training sample x in the training data set D_{S} and a classification result of the classification model with respect to the target sample y in the target data set D_{T} is calculated if the training sample x in the training data set D_{S} and the target sample y in the target data set D_{T} satisfy a condition of ∥f(x)−f(y)∥≤δ (that is, only the classification similarities between a classification result of the classification model with respect to each training sample x and classification results of the classification model with respect to the “similar” or “corresponding” target samples y are calculated in operation S101), and classification robustness of the classification model C with respect to the target data set D_{T} is calculated by calculating an expected value of all the obtained classification similarities (that is, calculating an average value of all the classification similarities).

In a way such as using the above equation (4), for each training sample in the training data set, in a neighborhood in the feature space (that is, a neighborhood with the sample as a center and the distance threshold δ as a radius), a proportion is counted of the case that the classification result of the classification model with respect to the training sample and the classification results of the classification model with respect to the corresponding (or similar) target samples is consistent with each other. A high proportion of the case that the classification result of the classification model with respect to the training sample and the classification results of the classification model with respect to the corresponding (or similar) target samples is consistent with each other corresponds to high classification robustness of the classification model with respect to the target data set.

Alternatively, if a distance threshold in the form of equation (2′), instead of equation (2), is used in operation S101 to determine the corresponding target samples y in the target data set D_{T} for the training sample x, equation (4) is replaced by following equation (4′):

$${R}^{2} ( C , T ) = \frac{{\sum }_{i = 1}^{N} {E}_{x ∼ {C}_{i} , y ∼ {D}_{T} , ‖ f ( x ) - f ( y ) ‖ \leq {δ}_{i}} [ 1 - ‖ c ( x ) - c ( y ) ‖ ]}{N} \qquad ( {4}^{′} )$$

In equation (4′), N represents the number of categories divided by the classification model, Cᵢ represents a set of training samples belonging to an i-th category in the training data set, and δᵢ represents a distance threshold of the i-th category, which is set as an intra-class average distance between features of the training samples belonging to the i-th category. Compared with equation (4), in equation (4′), the distance threshold δᵢ associated with each category is used in equation (4′), such that corresponding target samples are determined for training samples in each category more accurately, thereby estimating the classification robustness of the classification model with respect to the target data set more accurately.

An example flow of the robustness estimation method according to an embodiment of the present disclosure is described above with reference to FIG. 1 and FIG. 2. It should be noted that although equations (1) to (4′) are provided as a specific manner for determining the robustness with reference to FIG. 1 and FIG. 2, those skilled in the art may determine the robustness in any appropriate manner based on the embodiment, as long as the classification robustness of the classification model with respect to the target data set can be estimated based on the classification similarities between the classification result of the classification model with respect to the training sample and classification results of the classification model with respect to the corresponding (or similar) target samples. With the robustness estimation method according to the embodiment, the classification robustness of the classification model with respect to the target data set can be estimated in advance without obtaining the label of the target data. In addition, since the robustness estimation method only involves a calculation amount corresponding to the number N of categories of the classification model, that is, has small time complexity of O(N log N), the robustness estimation method is very suitable for estimating classification robustness of a classification model with respect to a large data set.

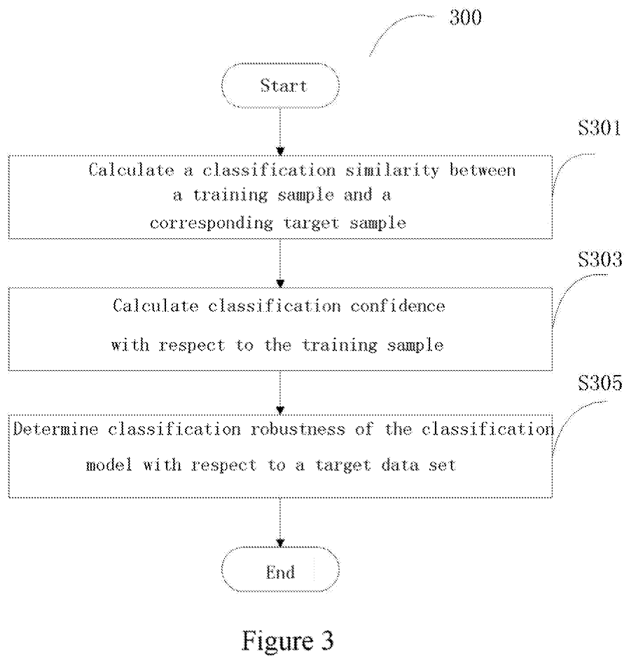

Based on the embodiments described with reference to FIG. 1 and FIG. 2, an example flow of a robustness estimation method according to another embodiment of the present disclosure is to be described with reference to FIG. 3 to FIG. 5.

Reference is made to FIG. 3, which shows an example flow of a robustness estimation method according to another embodiment of the present disclosure.

As shown in FIG. 3, the robustness estimation method 300 according to the embodiment differs from the robustness estimation method 100 shown in FIG. 1 in that, in addition to operations S301 and S305 respectively corresponding to the operations S101 and S103 shown in FIG. 1, the robustness estimation method 300 further includes operation S303 for determining classification confidence of the classification model with respect to each training sample based on a classification result of the classification model with respect to the training sample and a true category of the training sample. In addition, in operation S303 of the robustness estimation method 300 shown in FIG. 3, the classification robustness of the classification model with respect to the target data set is determined based on the classification similarities between the classification results of the respective training samples in the training data set and the classification results of the corresponding target samples in the target data set, and the classification confidence of the classification model with respect to the respective training samples.

Except for the above differences, operation S301 of the robustness estimation method 300 according to the embodiment is substantially the same as or similar to the corresponding operation S101 of the robustness estimation method 100 shown in FIG. 1.

Therefore, based on the embodiments described with reference to FIG. 1 and FIG. 2, differences of the present embodiment are mainly described still with reference to the classification model C and the examples of the training data set D_{S} and the target data set D_{T}, and common points are not described.

In the method 300 shown in FIG. 3, in addition to determining the classification similarity S(x, y), in a form such as equation (3), between the classification result c(x) of the classification model C with respect to each training sample x and the classification result c(y) of the classification model C with respect to the corresponding target sample y in operation S301 which is similar to operation S101 shown in FIG. 1, in operation S303, based on a classification result c(x) of the classification model C with respect to the training sample x and a true category (that is, a true label) label(x) of the training sample x, classification confidence Con(x) of the classification model C with respect to each training sample x is determined according to, for example, following equation (5).

Con(x)=1−∥label(x)−c(x)∥ (5)

In equation (5), label(x) represents a true category of the training sample x in a form of an N-dimensional vector similar to the classification result c(x), and Con(x) represents classification confidence of the training sample x calculated based on the L1 norm distances ∥label(x)−c(x)∥ between a true category label(x) of the training sample x and the classification results c(x). Con(x) has a value of 0 or 1. Con(x) is equal to 1 if the classification result c(x) of the classification model C with respect to the training sample x is consistent with the true category label(x) of the training sample x, and Con(x) is equal to 0 if the classification result c(x) of the classification model C with respect to the training sample x is not consistent with the true category label(x) of the training sample x.

After the classification confidence Con(x), for example, in a form of equation (5), is obtained in operation S303, the method 300 shown in FIG. 3 may proceed to operation S305. In operation S303, based on the classification similarities S(x, y) between classification results c(x) of respective training samples x in the training data set D_{S} and classification results c(y) of the corresponding target samples y in the target data set D_{T}, and the classification confidence Con(x) of the classification model C with respect to respective training samples x, classification robustness R³(C, T) of the classification model C with respect to the target data set D_{T} is determined:

R³(C,T)=E_{x˜D}_{_{S}}_{,y˜D}_{_{T}}_{,∥f(x)-f(y)∥≤δ}[1−∥C(x)−C(y)∥)×(1−∥label(x)−c(x)∥)] (6)

Compared with equation (4) in the embodiment described with reference to FIG. 1, in equation (6) according to the present embodiment, a term (1−∥label(x)−c(x)∥) for representing the classification confidence Con (x) of the training sample x is introduced. In this way, classification accuracy of the classification model on the training data set is additionally considered according to the embodiment, and impact of misclassified training samples and corresponding target samples is reduced in the robustness estimation process, thereby estimating robustness more accurately.

It should be noted that although a specific method for determining the classification robustness additionally based on the classification confidence of the training samples according to equation (5) and equation (6) is provided with reference to FIG. 3, those skilled in the art may estimate the classification robustness in any appropriate manner based on the embodiment, as long as the impact of misclassified training samples and corresponding target samples is reduced based on the classification confidence of the training samples, which is not described here. With the robustness estimation method according to the present embodiment, the classification confidence of the training samples is additionally considered in determining the classification robustness, thereby further improving the accuracy of the robustness estimation.

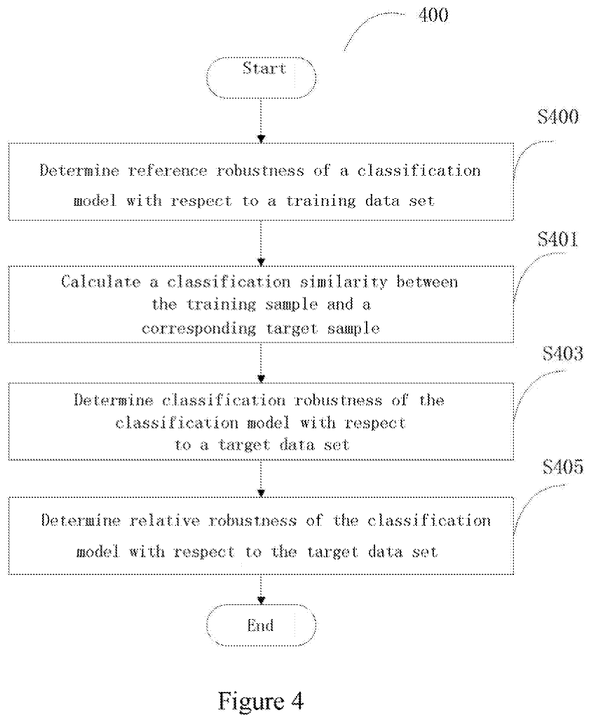

Reference is made to FIG. 4, which shows an example flow of a robustness estimation method according to another embodiment of the present disclosure.

As shown in FIG. 4, a robustness estimation method 400 according to the embodiment differs from the robustness estimation method 100 shown in FIG. 1 in that, in addition to operations S401 and S403 respectively corresponding to the operations S101 and S103 shown in FIG. 1, the robustness estimation method 400 further includes operations S400 and S405. In operation S400, reference robustness of the classification model with respect to the training data set is determined. In operation S405, relative robustness of the classification model with respect to the target data set is determined based on the classification robustness of the classification model with respect to the target data set and the reference robustness of the classification model with respect to the training data set.

Except for the above differences, operations S401 and S403 in the robustness estimation method 400 according to the embodiment are substantially the same as or similar to the corresponding operations S101 and S103 in the robustness estimation method 100 shown in FIG. 1. Therefore, based on the embodiments described with reference to FIG. 1 and FIG. 2, differences of the present embodiment are mainly described still with reference to the classification model C and the examples of the training data set D_{S} and the target data set D_{T}, and common points are not described.

In the method 400 shown in FIG. 4, firstly, reference robustness of the classification model with respect to the training data set is calculated in operation S400. By randomly dividing the training data set D_{S} into a training subset D_{S1} (a first subset) and a target subset D_{S2} (a second subset) and applying any one of the robustness estimation methods shown in FIGS. 1 to 3 to the training subset and the target subset, reference robustness of the classification model with respect to the training data set may be obtained.

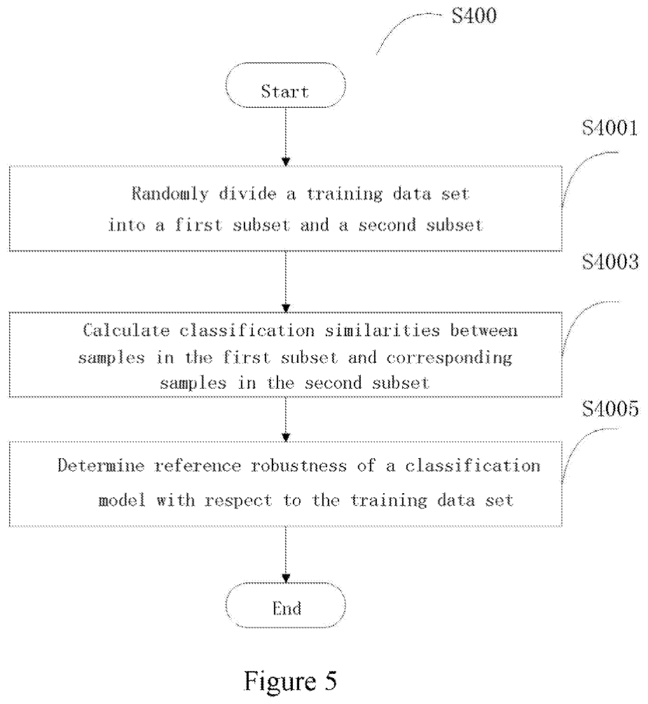

FIG. 5 shows a specific example of the operation S400. As shown in FIG. 5, the process in the example may include operations S4001, S4003 and S4005. In operation S4001, a first subset and a second subset with equal numbers of samples are obtained by randomly dividing the training data set. In operation S4003, for each training sample in the first subset, a training sample in the second subset whose similarity with the training sample is within a predetermined threshold range is determined, and a sample similarity between a classification result of the classification model with respect to the training sample in the first subset and a classification result of the classification model with respect to the determined training sample in the second subset is calculated. In operation S4005, reference robustness of the classification model with respect to the training data set is determined based on classification similarities between classification results of respective training samples in the first subset and classification results of corresponding training samples in the second subset.

Specifically, in operation S4001, a first subset D_{S1} and a second subset D_{S2} with equal numbers of samples are obtained by randomly dividing the training data set D_{S}.

In operation S4003, for each training sample x₁ in the first subset D_{S1}, a training sample x₂ in the second subset D_{S2} whose similarity with the training sample x₁ is within a predetermined threshold range is determined. For example, an L1 norm distance D(x₁,x₂)=∥f(x₂)−f(x₂)∥, in the form of equation (2), may be calculated to characterize sample similarity between samples x₁ and x₂, and a training sample x₂ having an L1 norm distance within the range of the distance threshold δ, that is, a training sample x₂ satisfying a condition of D(x₁,x₂)≤δ, in the second subset D_{S2} is determined as the corresponding training sample.

Then, a classification similarity S(x₁,x₂)=1−∥c(x₁)−c(x₂)∥ between a classification result c(x₁) of the classification model C with respect to the training sample x₁ in the first subset D_{S1} and a classification result c(x₂) of the classification model C with respect to the corresponding training sample x₂ in the second subset D_{S2} is calculated according to equation (3).

In operation S4005, based on classification similarities S(x₁,x₂) between classification results c(x₁) of respective training samples x₁ in the first subset D_{S1} and classification results c(x₂) of corresponding training samples x₂ in the second subset D_{S2}, reference robustness R⁰(C,S) of the classification model C with respect to the training data set S is determined, for example, according to equation (4):

$${R}^{0} ( C , S ) = {E}_{{x}_{1} ∼ {D}_{{S}_{1}} , {x}_{2} ∼ {D}_{{S}_{2}} , ‖ f ( {x}_{1} ) - f ( {x}_{2} ) ‖ \leq δ} [ 1 - ‖ c ( x ) - c ( y ) ‖ ] \qquad ( 7 )$$

It should be noted that although the equation (4) is used here to determine the reference robustness of the classification model C with respect to the training data set S, any manner suitable for determining the classification robustness according to the present disclosure (such as the manner of equation (4′) or (6)) may be used to determine the reference robustness, as long as the manner for determining the reference robustness is consistent with the manner for determining the classification robustness (hereinafter also referred to as absolute robustness) of the classification model with respect to the target data set in operation S403.

Referring back to FIG. 4, after obtaining the reference robustness R⁰(C,S) by, for example, the manner described with reference to FIG. 5, and after determining the absolute robustness R¹(C,S) of the classification model respect to the target data set, in a form such as equation (4), by operations S401 and S403 which are respectively similar to operations S101 and S103 shown in FIG. 1, the method 400 may proceed to operation S405.

In operation S405, based on the absolute robustness R¹(C,S) in a form such as equation (4) and the reference robustness R⁰(C,S) in a form such as equation (7), relative robustness may be determined:

$${R}^{4} ( C , T ) = \frac{{R}^{1} ( C , S )}{{R}^{0} ( C , S )}$$

that is,

$${R}^{4} ( C , T ) = \frac{{E}_{x ∼ {D}_{S} , y ∼ {D}_{T} , ‖ f ( x ) - f ( y ) ‖ \leq δ} [ 1 - ‖ c ( x ) - c ( y ) ‖ ]}{{E}_{{x}_{1} ∼ {D}_{{S}_{1}} , {x}_{2} ∼ {D}_{{S}_{2}} , ‖ f ( {x}_{1} ) - f ( {x}_{2} ) ‖ \leq δ} [ 1 - ‖ c ( {x}_{1} ) - c ( {x}_{2} ) ‖ ]} \qquad ( 8 )$$

By calculating the reference robustness of the classification model with respect to the training data set and calculating the relative robustness based on the reference robustness and the absolute robustness, the effect of calibrating classification robustness is realized, thereby avoiding the influence of the bias of the classification model on the estimation of the classification robustness.

It should be noted that although equations (7) and (8) are provided as a specific manner for determining the relative robustness with reference to FIG. 4 and FIG. 5, those skilled in the art may calculate the relative robustness in any appropriate manner based on the embodiment, as long as the absolute robustness of the classification model with respect to the target data set can be calibrated based on the reference robustness of the classification model with respect to the training data set, which is not described here. With the robustness estimation method according to the present embodiment, bias of the classification model in training can be corrected by the calibration of the classification robustness, thereby further improving the accuracy of the robustness estimation.

The robustness estimation methods according to the embodiments of the present disclosure described with reference to FIG. 1 to FIG. 5 may be combined with each other, thus different robustness estimation methods may be adopted in different application scenarios. For example, the robustness estimation methods of the various embodiments of the present disclosure may be combined with each other for different configurations in the following three aspects. In determining a corresponding target sample for a training sample, it may be configured a same similarity threshold or different similarity thresholds are to be used for each category of training samples (for example, determining the corresponding target sample according to equation (2) or (2′) and calculating the robustness according to equation (4) or (4′)); in calculating the classification robustness of the classification model with respect to the target data set, it may be configured whether the classification confidence of the training sample is considered (calculating the robustness according to equation (4) or (6)); and in calculating the classification robustness of the classification model with respect to the target data set, it may be configured whether to calculate the relative robustness or the absolute robustness (calculating the robustness by equation (4) or (7)). Correspondingly, eight different robustness estimation methods can be obtained, and an appropriate method is adopted in each application scenario.

Next, an evaluation method for evaluating the accuracy of the robustness estimation method and the accuracies of the multiple robustness estimation methods according to the embodiments of the present disclosure evaluated with the evaluation method are described.

As an example, an average estimation error (AEE) of a robust estimation method may be calculated based on a robustness truth value and an estimated robustness of each of multiple classification models with the robustness estimation method. The accuracy of the robustness estimation method can be thus evaluated.

More specifically, the classification accuracy is taken as an example index of the performance of the classification model, and a robustness truth value is defined in a form of equation (9):

$$G = \frac{min ( a c {c}_{S} , {acc}_{T} )}{{acc}_{S}} \qquad ( 9 )$$

Equation (9) represents a ratio of classification accuracy acc_{T} of a classification model with respect to a target data set T to classification accuracy acc_{S} of the classification model with respect to a training data set or a test set S corresponding to the training data set (such as a test set that is independent and identically distributed with respect to the training data set). Since the classification accuracy acc_{T} of the classification model with respect to the target data set may be higher than the classification accuracy acc_{S} of the classification model with respect to the test set, a minimum one of acc_{T} and acc_{S} is used on the numerator of equation (9), to limit the range of the robustness truth value G between 0 and 1 to facilitate subsequent operations. For example, if the classification accuracy acc_{S} of the classification model with respect to the test set is 0.95, and the classification accuracy acc_{T} of the classification model with respect to the target data set drops to 0.80, the robustness truth value G of the classification model with respect to the target data set is to be 0.84. A high robustness truth value G indicates that the classification accuracy of the classification model with respect to the target data set is close to the accuracy of the classification accuracy of the classification model with respect to the test set.

Based on robustness truth values, in form of equation (9), calculated for multiple classification models, and estimated robustness of respective classification models obtained by a robustness estimation method, it may be determined whether the robustness estimation method is effective. For example, an average estimation error AEE, in a form of equation (10), may be adopted as an evaluation index:

$$AEE = \frac{{\sum }_{j}^{M} \frac{\vert {R}_{j} - {G}_{j} \vert}{{G}_{j}}}{M} \qquad ( 10 )$$

In equation (10), M represents the number of classification models used for robustness estimation with a robustness estimation method (M is a natural number greater than 1); Rⱼ represents estimated robustness of a j-th classification model obtained with the robustness estimation method; and Gⱼ (j=1, 2, . . . M) represents a robustness truth value of the j-th classification model obtained by using equation (9). An average error rate of estimation results of the robustness estimation method can be reflected by calculating the average estimation error AEE in the above manner, and a small AEE corresponds to a high accuracy of the robustness estimation method.

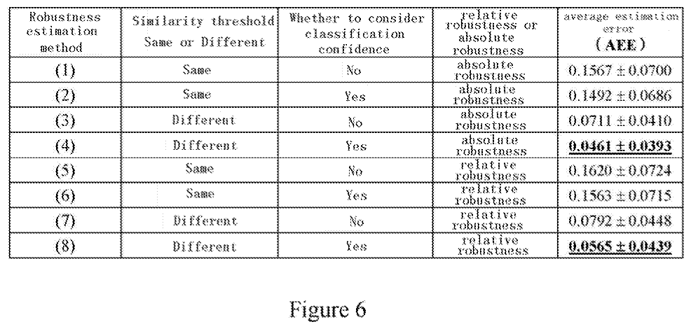

With the calculation method of the average estimation error in a form of the formula (10), the accuracy of the robustness estimation method according to the embodiment of the present disclosure can be evaluated with respect to an application example. FIG. 6 is an example table for explaining accuracy of each of the robustness estimation methods according to embodiments of the present disclosure, which shows average estimation errors (AEE) of the robust estimation methods (1) to (8) calculated according to equation (10) with respect to an application example.

In the application example shown in FIG. 6, classification robustness of each classification model C^{j} (j=1, 2 . . . M, and M=10) in M classification models is estimated by each one of the eight robustness estimation methods numbered as (1) to (8). Based on estimated robustness of respective classification models by all the robustness estimation methods and the robustness truth values of respective classification models, average estimation errors (AEE) of all the robustness estimation methods shown in the rightmost column of the table as shown in FIG. 6 are calculated according to equation (10).

Each classification model C^{j} in the application example shown in FIG. 6 is a CNN model for classifying image samples into one of N predetermined categories (NJ is a natural number greater than 1). Training data set D_{S} for training the classification model C^{j} is a subset of an MNIST handwritten character set, and target data set D_{T} to which the classification model Cⱼ is to be applied is a subset of an USPS handwritten character set.

The robustness estimation methods (1) to (8) used in the application example shown in FIG. 6 are obtained by directly adopting the robustness estimation methods according to the embodiments of the present disclosure described with reference to FIG. 1 to FIG. 5 or adopting a combination of one or more of the robustness estimation methods. As shown in the middle three columns of the table shown in FIG. 6, the robustness estimation methods (1) to (8) may adopt different configurations in the following three aspects. In determining a corresponding target sample for a training sample, it may be configured whether a same similarity threshold or different similarity thresholds are to be used for each training sample category (such as determining the corresponding target sample by equation (2) or (2′) and calculating the robustness by equation (4) or (4′)); in calculating the classification robustness of the classification model with respect to the target data set, it may be configured whether the classification confidence of the training sample is considered (calculating the robustness by equation (4) or (6)); and in calculating the classification robustness of the classification model with respect to the target data set, it may be configured whether to calculate the relative robustness or the absolute robustness (calculating the robustness by equation (4) or (7)).

For the robust estimation methods (1) to (8) adopting different configurations in the three aspects, average estimation errors (AEEs) calculated by using equation (10) are shown in the rightmost column of the table shown in FIG. 6. It can be seen from the calculation results of the AEE in the table shown in FIG. 6 that, with the robustness estimation methods according to the embodiments of the present disclosure, a low estimation error can be obtained. Moreover, as shown in the table in FIG. 6, the average estimation error can be further reduced by setting different similarity thresholds and taking into account the classification confidence of the training samples, and a smallest average estimation error is only 0.0461. In addition, although in this example, an average estimation error of a robustness estimation method in which relatively robustness is adopted is worse than an average estimation error of a robustness estimation method in which absolute robustness is adopted, the robustness estimation method in which relative robustness is adopted may have better accuracy in some situations (such as, a situation of the classification model that has a bias).

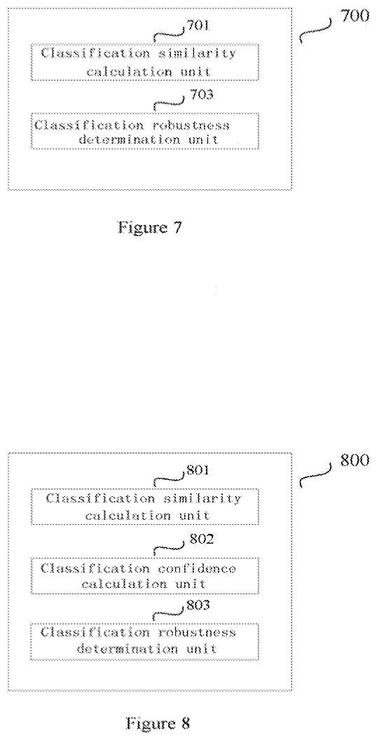

A robustness estimation apparatus is further provided according to an embodiment of the present disclosure. The robustness estimation apparatus according to the embodiment of the present disclosure is described with reference to FIG. 7 to FIG. 9.

FIG. 7 is a schematic block diagram schematically showing an example structure of a robustness estimation apparatus according to an embodiment of the present disclosure.

As shown in FIG. 7, the robustness estimation apparatus 700 may include a classification similarity calculation unit 701 and a classification robustness determination unit 703. The classification similarity calculation unit 701 is configured to, for each training sample in the training data set, determine a target sample in a target data set whose sample similarity with the training sample is within a predetermined threshold range, and calculate a classification similarity between a classification result of the classification model with respect to the training sample and a classification result of the classification model with respect to the determined target sample. The classification robustness determination unit 703 is configured to, based on classification similarities between classification results of respective training samples in the training data set and classification results of corresponding target samples in the target data set, determine classification robustness of the classification model with respect to the target data set.

The robustness estimation apparatus and respective units thereof, for example, can be configured to perform the operations and/or processes performed in the robustness estimation methods and respective operations thereof described above with reference to FIG. 1 and FIG. 2, and achieve similar effects, which is not be repeated here.

FIG. 8 is a schematic block diagram schematically showing an example structure of a robustness estimation apparatus according to another embodiment of the present disclosure.

As shown in FIG. 8, the robustness estimation apparatus 800 according to the embodiment differs from the robustness estimation apparatus 700 shown in FIG. 7 in that, in addition to a classification similarity calculation unit 801 and a classification robustness determination unit 803 which respectively correspond to the classification similarity calculation unit 701 and the classification robustness determination unit 703 shown in FIG. 7, the robustness estimation apparatus 800 further includes a classification confidence calculation unit 802. The classification confidence calculation unit 802 is configured to determine classification confidence of the classification model with respect to each training sample based on a classification result of the classification model with respect to the training sample and a true category of the training sample. In addition, the classification robustness determination unit 803 of the robustness estimation apparatus 800 shown in FIG. 8 is further configured to determine the classification robustness of the classification model with respect to the target data set based on the classification similarities between the classification results of the respective training samples in the training data set and the classification results of the corresponding target samples in the target data set, and the classification confidence of the classification model with respect to the respective training samples.

The robustness estimation apparatus and respective units thereof, for example, can be configured to perform the operations and/or processes performed in the robustness estimation method and respective operations thereof described above with reference to FIG. 3, and achieve similar effects, which is not be repeated here.

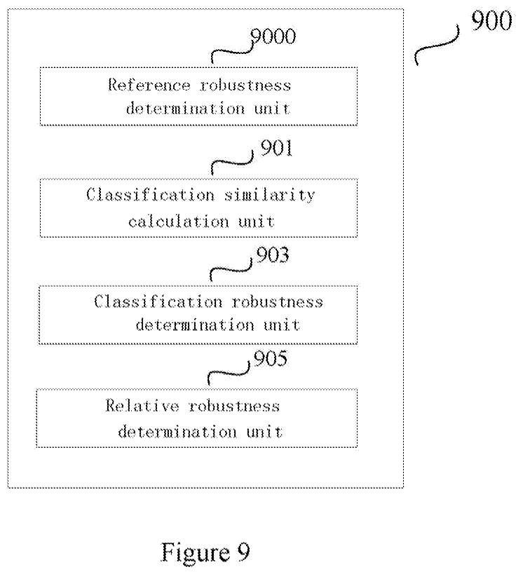

FIG. 9 is a schematic block diagram schematically showing an example structure of a robustness estimation apparatus according to another embodiment of the present disclosure.

As shown in FIG. 9, the robustness estimation apparatus 900 according to the embodiment differs from the robustness estimation apparatus 700 shown in FIG. 7 in that, in addition to a classification similarity calculation unit 901 and a classification robustness determination unit 903 which respectively correspond to the classification similarity calculation unit 701 and the classification robustness determination unit 703 shown in FIG. 7, the robustness estimation apparatus 900 further includes a reference robustness determination unit 9000 and a relative robustness determination unit 905. The reference robustness determination unit 9000 is configured to determine reference robustness of the classification model with respect to the training data set. The relative robustness determination unit 905 is configured to determine relative robustness of the classification model with respect to the target data set based on the classification robustness of the classification model with respect to the target data set and the reference robustness of the classification model with respect to the training data set.

The robustness estimation apparatus and respective units thereof, for example, can be configured to perform the operations and/or processes performed in the robustness estimation methods and respective operations thereof described above with reference to FIG. 4 and FIG. 5, and achieve similar effects, which is not be repeated here.

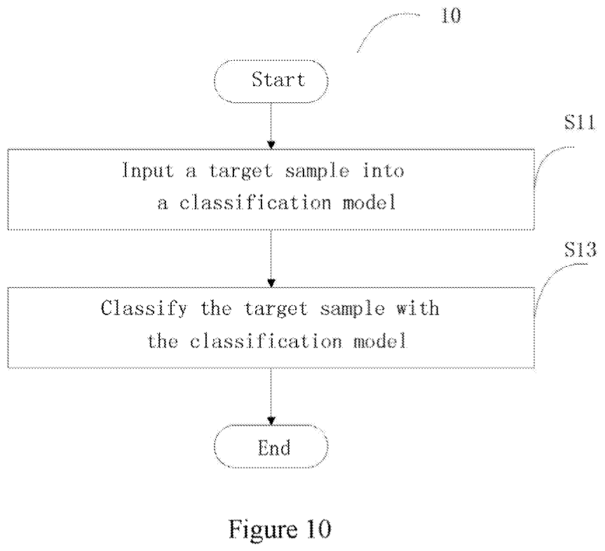

A data processing method is further provided according to an embodiment of the present disclosure, which is used for performing data classification with a classification model having good robustness selected with a robustness estimation method according to an embodiment of the present disclosure. FIG. 10 is a flow chart schematically showing an example flow of using a classification model having good robustness determined with a robustness estimation method according to an embodiment of the present disclosure to perform data processing.

As shown in FIG. 10, the data processing method 10 includes operation S11 and S13. In operation S11, a target sample is inputted into a classification model. In operation S13, the target sample is classified with the classification model. Further, the classification model is obtained in advance through training with a training data set. Classification robustness of the classification model with respect to a target data set to which the target sample belongs exceeds a predetermined robustness threshold, the classification robustness being estimated by a robustness estimation method according to any one of the embodiments of the present disclosure with reference to FIG. 1 to FIG. 5 (or a combination of such robustness estimation methods).

As discussed in describing the robustness estimation method according the embodiments of the present disclosure, the robustness estimation methods according to the embodiments of the present disclosure may be applied to classification models for various types of data including image data and time-series data, and the classification models may be in any appropriate forms such as a CNN model or a RNN model. Correspondingly, the classification model having good robustness which is selected by the robustness estimation method (that is, a classification model having high robustness estimated by the robustness estimation method) may be applied to various data processing fields with respect to the above various types of data, thereby ensuring that the selected classification model may have good classification performance with respect to the target data set, thus improving the performance of subsequent data processing.

Taking the classification of image data as an example, since it results in a high cost (of time, resource, or the like) to label real-world pictures, labeled images obtained in advance in other ways (such as existing training data samples) may be used as a training data set in training a classification model. However, such labeled images obtained in advance may not be completely consistent with real-world pictures, thus the performance of the classification model, which is trained based on such labeled images obtained in advance, with respect to a real-world target data set may greatly degrade. Therefore, with the robustness estimation method according to the embodiment of the present disclosure, classification robustness of the classification model, which is trained based on a training data set obtained in advance in other ways, with respect to a real-world target data set can be estimated, then a classification model having good robustness can be selected before an actual deployment and application, thereby improving the performance of subsequent data processing.

As an example, multiple application examples to which the method shown in FIG. 10 may be applied are described below. The multiple application examples involve the following types of classification models: an image classification model for semantic segmentation, an image classification model for handwritten character recognition, an image classification model for traffic sign recognition, and a time-series data classification model for weather forecast.

### First Application Example

The first application example of the data processing method according to an embodiment of the present disclosure may involve semantic segmentation. Semantic segmentation indicates that a given image is segmented into different parts that represent different objects (such as identifying different objects with different colors). Principle of the semantic segmentation is to classify each pixel in the image into one of multiple predefined object categories with a classification model.

In the application of semantic segmentation, since it results in a high cost (of time, resource, or the like) to label real-world pictures, pre-labeled pictures of a scenario in a simulation environment (such as a 3D game) may be used as a training data set in training a classification model for semantic segmentation. Compared with real-world pictures, it is easy to realize automatic labeling of objects through programming in the simulation environment, and thus it is easy to obtain labeled training samples. However, since the simulation environment may not be completely consistent with the real environment, the performance of the classification model, which is trained based on the training samples in the simulation environment, with respect to a target data set in the real environment may greatly degrade.

Therefore, with the robustness estimation method according to the embodiment of the present disclosure, classification robustness of the classification model, which is trained based on a training data set in the simulation environment, with respect to a target data set in the real environment can be estimated, and then a classification model having good robustness can be selected before actual deployment and application, thereby improving the performance of subsequent data processing.

### Second Application Example

The second application example of the data processing method according to an embodiment of the present disclosure may involve recognition of images such as traffic signs. Recognition of images such as traffic signs may be realized by classifying traffic signs included in a given image into one of multiple predefined sign categories, which is of great significance in areas such as autonomous driving.

Similar to the application example of semantic segmentation, pre-labeled pictures of a scenario in a simulation environment (such as a 3D game) may be used as a training data set in training a classification model for traffic sign recognition. With the robustness estimation method according to the embodiment of the present disclosure, classification robustness of the classification model, which is trained based on a training data set in the simulation environment, with respect to a target data set in the real environment can be estimated, and then a classification model having good robustness can be selected before actual deployment and application, thereby improving the performance of subsequent data processing.

### Third Application Example

The third application example of the data processing method according to an embodiment of the present disclosure may involve, for example, recognition of handwritten characters (numbers and characters). Recognition of handwritten characters may be realized by classifying characters included in a given image into one of multiple predefined character categories.

Since it results in a high cost (of time, resource, or the like) to label images of handwritten characters that are actually taken, an existing labeled handwritten character set, such as MNIST, USPS, and SVHN, may be used as a training data set in training a classification model for handwritten character recognition. With the robustness estimation method according to the embodiment of the present disclosure, classification robustness of the classification model, which is trained based on such a training data set, with respect to images (that is, a target data set) of handwritten characters taken in the real environment can be estimated, and then a classification model having good robustness can be selected before actual deployment and application, thereby improving the performance of subsequent data processing.

### Fourth Application Example

In addition to application scenarios based on image classification, an application example of the data processing method according to an embodiment of the present disclosure may further involves time-series data classification, such as an application example 4 for a time-series data classification model for performing weather forecast. The time-series data classification model for weather forecast may be used to forecast a weather index after a certain time period based on time-series weather data for characterizing the weather during the certain time period, that is, to indicate one of multiple predefined weather index categories.

As an example, input data of the time-series data classification model for performing weather forecast may be time-series data in a certain time interval (for example, two hours) of information in eight dimensions in a certain time period (for example, in three days), including time, PM2.5 index, temperature, barometric pressure, wind speed, wind direction, accumulated rainfall, and accumulated snowfall. An output of the time-series data classification model may be one of multiple predefined PM2.5 index ranges.

Such a classification model, for example, may be trained based on a training data set with respect to an area A, and may be applied to perform weather forecast for an area B. As another example, the classification model may be trained based on a training data set with respect to spring, and may be applied to perform weather forecast for autumn. With the robustness estimation method according to the embodiment of the present disclosure, classification robustness of the classification model, which is trained based on a training data set of a predetermined area or season (or time), with respect to a target data set of a different area or season (or time) can be estimated, and then a classification model having good robustness can be selected before actual deployment and application, thereby improving the performance of subsequent data processing.

Application examples of image data classification and time-series data classification are described above, as application scenarios in which the robustness estimation method according to the embodiment of the present disclosure and the corresponding classification model can be used for data processing. Based on the application examples, those skilled in the art should understand that, as long as performance of a classification model with respect to a target data set is different from performance of the classification model with respect to a training data set due to that the training data set and the target data set are not independent and identically distributed, the robustness estimation method according to the embodiment of the present disclosure can be applied to estimate the robustness of the classification model with respect to the target data set, and a classification model having good robustness is selected, thereby improving the performance of subsequent data processing.

An information processing apparatus is further provided according to an aspect of the present disclosure, which is configured to perform the robustness estimation method according to the embodiments of the present disclosure. The information processing apparatus may include a processor. The processor is configured to, for each training sample in a training data set, determine a target sample in a target data set whose sample similarity with the training sample is within a predetermined threshold range, and calculate a classification similarity between a classification result of a classification model with respect to the training sample and a classification result of the classification model with respect to the determined target sample, where the classification model is obtained in advance through training based on the training data set. The processor is further configured to determine, based on classification similarities between classification results of respective training samples in the training data set and classification results of corresponding target samples in the target data set, classification robustness of the classification model with respect to the target data set.

The processor of the information processing apparatus, for example, can be configured to perform the operations and/or processes performed in the robustness estimation methods and respective operations thereof described above with reference to FIG. 1 to FIG. 5, and achieve similar effects, which is not be repeated here.

As an example, both the training data set and the target data set include image data samples or time-series data samples.

In a preferred embodiment, the processor of the information processing apparatus is further configured to determine classification confidence of the classification model with respect to each training sample, based on a classification result of the classification model with respect to the training sample and a true category of the training sample. The classification robustness of the classification model with respect to the target data set is determined based on the classification similarities between the classification results of the respective training samples in the training data set and the classification results of the corresponding target samples in the target data set, and the classification confidence of the classification model with respect to the training samples.

In a preferred embodiment, the processor of the information processing apparatus is further configured to:

obtain a first subset and a second subset with equal numbers of samples by randomly dividing the training data set;

for each training sample in the first subset, determine a training sample in the second subset whose similarity with the training sample is within a predetermined threshold range, and calculate a sample similarity between a classification result of the classification model with respect to the training sample in the first subset and a classification result of the classification model with respect to the determined training sample in the second subset; determine, based on classification similarities between classification results of respective training samples in the first subset and classification results of corresponding training samples in the second subset, reference robustness of the classification model with respect to the training data set; and determine, based on the classification robustness of the classification model with respect to the target data set and the reference robustness of the classification model with respect to the training data set, relative robustness of the classification model with respect to the target data set.

In a preferred embodiment, the processor of the information processing apparatus is further configured to, in determining the target sample in the target data set whose sample similarity with the training sample is within the predetermined threshold range, take a similarity threshold associated with a category to which the training sample belongs as the predetermined threshold.

Preferably, the similarity threshold associated with the category to which the training sample belongs includes an average sample similarity among training samples that belong to the category in the training data set.

In a preferred embodiment, the processor of the information processing apparatus is further configured to, in determining the target sample in the target data set whose sample similarity with the training sample is within the predetermined threshold range, take feature similarities between a feature extracted with the classification model from the training sample and features extracted with the classification model from respective target samples in the target data set as sample similarities between the training sample and the respective target samples.

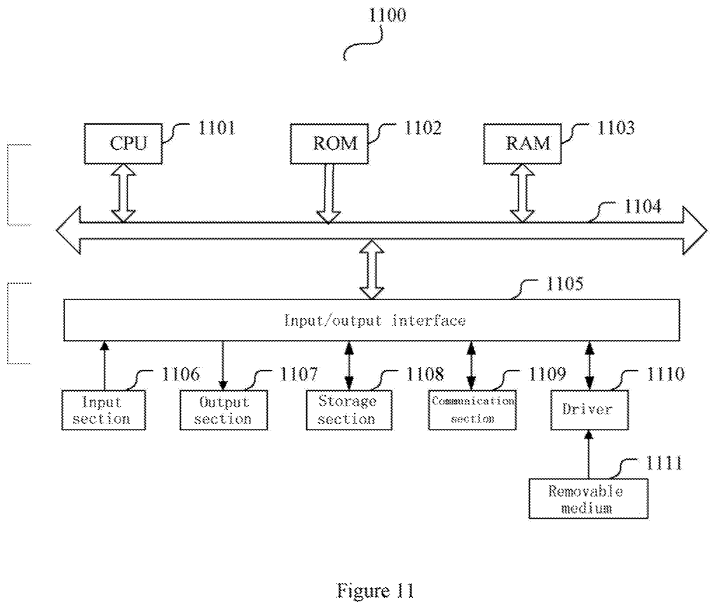

FIG. 11 is a structural diagram showing an exemplary hardware configuration 1100 for implementing a robustness estimation method, a robustness estimation apparatus and an information processing apparatus according to embodiments of the present disclosure.

In FIG. 11, a central processing unit (CPU) 1101 performs various types of processing according to a program stored in a read only memory (ROM) 1102 or a program loaded from a storage section 1108 to a random access memory (RAM) 1103. The RAM 1103 also stores the data required for the CPU 1101 to execute various types of processing. The CPU 1101, the ROM 1102, and the RAM 1103 are connected to each other via a bus 1104. An input/output interface 1105 is also connected to the bus 1104.

The following components are also connected to the input/output interface 1105: an input section 1106 (including a keyboard, a mouse, and the like), an output section 1107 (including a display such as a cathode ray tube (CRT) or a liquid crystal display (LCD), a speaker, and the like), the storage section 1108 (including a hard disk, and the like), and a communication section 1109 (including a network interface card such as a LAN card, a modem, and the like). The communication section 1109 performs communication via the network such as Internet. A driver 1110 is also connected to the input/output interface 1105 as required. A removable medium 1111, such as a magnetic disk, an optical disk, an optic-magnetic disk, a semiconductor memory, or the like, can be installed on the driver 1110 as required so that a computer program fetched therefrom can be installed into the storage section 1108 as needed.

In addition, a program product storing machine-readable instruction codes is provided according to the present disclosure. The instruction codes, when being read and executed by a machine, cause the machine to perform the robustness estimation method according to the embodiment of the present disclosure. Accordingly, various storage media such as a magnetic disk, an optical disk, an optic-magnetic disk, a semiconductor memory, or the like for carrying such a program product are also included in the present disclosure.

In addition, a storage medium storing the machine-readable instruction codes, is further provided according to the present disclosure. The instruction codes, when being read and executed by a machine, causes the machine to perform the robustness estimation method according to the embodiment of the present disclosure. The instruction codes include instruction codes for performing the following operations:

for each training sample in the training data set, determining a target sample in a target data set whose sample similarity with the training sample is within a predetermined threshold range, and calculating a classification similarity between a classification result of the classification model with respect to the training sample and a classification result of the classification model with respect to the determined target sample, where the classification model is obtained in advance through training based on the training data set; and

determining, based on classification similarities between classification results of respective training samples in the training data set and classification results of corresponding target samples in the target data set, classification robustness of the classification model with respect to the target data set.

The storage medium may include, but is not limited to, a magnetic disk, an optical disk, an optic-magnetic disk, a semiconductor memory, and the like.

In the above description of specific embodiments of the present disclosure, features that are described and/or illustrated with respect to one embodiment may be used in the same way or in a similar way in one or more other embodiments and in combination with or instead of the features of the other embodiments.

In addition, the methods according to the embodiments of the present disclosure are not limited to being performed in the chronological order described in the specification or shown in the drawings, but may also be performed in other chronological order, in parallel, or independently. Therefore, the execution order of the methods described in the specification does not limit the technical scope of the present disclosure.

In addition, it is apparent that each operation process of the method according to the present disclosure may be implemented in a form of a computer-executable program stored in various machine-readable storage media.

Moreover, the purpose of the present disclosure can be achieved as follows. A storage medium storing executable program codes is directly or indirectly provided to a system or device, and a computer or a central processing unit (CPU) in the system or device reads and executes the program codes.

Here, the implementation of the present disclosure is not limited to a program as long as the system or device has a function to execute the program, and the program can be in arbitrary forms such as an objective program, a program executed by an interpreter, or a script program provided to an operating system.

The machine-readable storage media include, but are not limited to, various memories and storage units, semiconductor devices, magnetic disk units such as optical, magnetic, and magneto-optical disks, and other media suitable for storing information.

In addition, a client information processing terminal can also implement the embodiments of the present disclosure by connecting to a corresponding website in the Internet, loading the computer program codes of the present disclosure and installing the computer program codes to the client information processing terminal, and then executing the program.

As such, any of the embodiments described herein can be implemented using hardware, software, or combination thereof where a computing hardware (computing apparatus) and/or software, such as (in a non-limiting example) any computer that can store, retrieve, process and/or output data and/or communicate with other computers can be used.

In summary, based on the embodiments of the present disclosure, the following schemes 1 to 17 are provided according to the present disclosure, however, the present disclosure is not limited thereto.

Scheme 1, A robustness estimation method for estimating robustness of a classification model which is obtained in advance through training based on a training data set, the method including:

for each training sample in the training data set, determining a target sample in a target data set whose sample similarity with the training sample is within a predetermined threshold range, and calculating a classification similarity between a classification result of the classification model with respect to the training sample and a classification result of the classification model with respect to the determined target sample; and determining, based on classification similarities between classification results of respective training samples in the training data set and classification results of corresponding target samples in the target data set, classification robustness of the classification model with respect to the target data set.

Scheme 2, The robustness estimation method according to scheme 1, further including:

determining classification confidence of the classification model with respect to each training sample, based on a classification result of the classification model with respect to the training sample and a true category of the training sample,

where the classification robustness of the classification model with respect to the target data set is determined based on the classification similarities between the classification results of the respective training samples in the training data set and the classification results of the corresponding target samples in the target data set, and the classification confidence of the classification model with respect to the training samples.

Scheme 3, The robustness estimation method according to scheme 1, further including:

obtaining a first subset and a second subset with equal numbers of samples by randomly dividing the training data set;

for each training sample in the first subset, determining a training sample in the second subset whose similarity with the training sample is within a predetermined threshold range, and calculating a classification similarity between a classification result of the classification model with respect to the training sample in the first subset and a classification result of the classification model with respect to the determined training sample in the second subset;

determining, based on classification similarities between classification results of respective training samples in the first subset and classification results of corresponding training samples in the second subset, reference robustness of the classification model with respect to the training data set; and

determining, based on the classification robustness of the classification model with respect to the target data set and the reference robustness of the classification model with respect to the training data set, relative robustness of the classification model with respect to the target data set.

Scheme 4, The robustness estimation method according to any one of schemes 1 to 3, where in determining the target sample in the target data set whose sample similarity with the training sample is within the predetermined threshold range, a similarity threshold associated with a category to which the training sample belongs is taken as the predetermined threshold.

Scheme 5, The robustness estimation method according to scheme 4, where the similarity threshold associated with the category to which the training sample belongs includes: an average sample similarity among training samples that belong to the category in the training data set.

Scheme 6, The robustness estimation method according to any one of schemes 1 to 3, where in determining the target sample in the target data set whose sample similarity with the training sample is within the predetermined threshold range, feature similarities between a feature extracted with the classification model from the training sample and features extracted with the classification model from respective target samples in the target data set are taken as sample similarities between the training sample and the respective target samples.

Scheme 7, The robustness estimation method according to any one schemes 1 to 3, where both the training data set and the target data set include image data samples or time-series data samples.

Scheme 8, A data processing method, including:

inputting a target sample into a classification model, and

classifying the target sample with the classification model,

where the classification model is obtained in advance through training with a training data set, and

where classification robustness of the classification model with respect to a target data set to which the target sample belongs exceeds a predetermined robustness threshold, the classification robustness being estimated by the robustness estimation method according to any one of schemes 1 to 7.

Scheme 9, The data processing method according to scheme 8, where

the classification model includes one of: an image classification model for semantic segmentation, an image classification model for handwritten character recognition, an image classification model for traffic sign recognition, and a time-series data classification model for weather forecast.

Scheme 10, An information processing apparatus, including:

a processor configured to:

for each training sample in a training data set, determine a target sample in a target data set whose sample similarity with the training sample is within a predetermined threshold range, and calculate a classification similarity between a classification result of a classification model with respect to the training sample and a classification result of the classification model with respect to the determined target sample, where the classification model is obtained in advance through training based on the training data set; and

determine, based on classification similarities between classification results of respective training samples in the training data set and classification results of corresponding target samples in the target data set, classification robustness of the classification model with respect to the target data set.

Scheme 11, The information processing apparatus according to scheme 10, where the processor is further configured to:

determine classification confidence of the classification model with respect to each training sample, based on a classification result of the classification model with respect to the training sample and a true category of the training sample,

where the classification robustness of the classification model with respect to the target data set is determined based on the classification similarities between the classification results of the respective training samples in the training data set and the classification results of the corresponding target samples in the target data set, and the classification confidence of the classification model with respect to the training samples.

Scheme 12, The information processing apparatus according to scheme 10, where the processor is further configured to:

obtain a first subset and a second subset with equal numbers of samples by randomly dividing the training data set;

for each training sample in the first subset, determine a training sample in the second subset whose similarity with the training sample is within a predetermined threshold range, and calculate a sample similarity between a classification result of the classification model with respect to the training sample in the first subset and a classification result of the classification model with respect to the determined training sample in the second subset;

determine, based on classification similarities between classification results of respective training samples in the first subset and classification results of corresponding training samples in the second subset, reference robustness of the classification model with respect to the training data set; and

determine, based on the classification robustness of the classification model with respect to the target data set and the reference robustness of the classification model with respect to the training data set, relative robustness of the classification model with respect to the target data set.

Scheme 13, The information processing apparatus according to any one of schemes 10 to 12, where the processor is further configured to, in determining the target sample in the target data set whose sample similarity with the training sample is within the predetermined threshold range, use a similarity threshold associated with a category to which the training sample belongs as the predetermined threshold.

Scheme 14, The information processing apparatus according to scheme 13, where the similarity threshold associated with the category to which the training sample belongs includes: an average sample similarity among training samples that belong to the category in the training data set.

Scheme 15, The information processing apparatus according to any one of schemes 10 to 12, where the processor is further configured to, in determining the target sample in the target data set whose sample similarity with the training sample is within the predetermined threshold range, use feature similarities between a feature extracted with the classification model from the training sample and features extracted with the classification model from respective target samples in the target data set as sample similarities between the training sample and the respective target samples.

Scheme 16, The information processing apparatus according to any one of schemes 10 to 12, where both the training data set and the target data set comprise image data samples or time-series data samples.

Scheme 17, A storage medium having machine-readable instruction codes stored therein, where the instruction codes, when being read and executed by a machine, cause the machine to execute a robustness estimation method, the robustness estimation method includes:

for each training sample in the training data set, determining a target sample in a target data set whose sample similarity with the training sample is within a predetermined threshold range, and calculating a classification similarity between a classification result of the classification model with respect to the training sample and a classification result of the classification model with respect to the determined target sample, where the classification model is obtained in advance through training based on the training data set; and

determining, based on classification similarities between classification results of respective training samples in the training data set and classification results of corresponding target samples in the target data set, classification robustness of the classification model with respect to the target data set.

Finally, it should be further noted that the relationship terminologies such as “first”, “second” and the like are only used herein to distinguish one entity or operation from another entity or operation, rather than to necessitate or imply that the actual relationship or order exists between the entities or operations. Furthermore, terms of “include”, “comprise”, or any other variants are intended to encompass non-exclusive inclusion. Therefore, a process, method, article, or device including multiple elements may include not only the elements but also other elements that are not explicitly listed, or also include the elements inherent for the process, method, article or device. Unless expressively limited otherwise, the statement “comprising (including) a/an . . . ” does not exclude a case that other similar elements may exist in the process, method, article or device.

Although the disclosure has been disclosed above through the description of specific embodiments thereof, it should be understood that those skilled in the art can design multiple modifications, improvements, or equivalents to the disclosure within the spirit and scope of the appended claims. These modifications, improvements or equivalents should also be considered to be included in the scope claimed by the present disclosure.

What is claimed is:

1. A robustness estimation method for estimating robustness of a classification model which is obtained in advance through training based on a training data set, the method comprising:
for each training sample in the training data set, determining a respective target sample in a target data set that has a sample similarity with a respective training sample that is within a predetermined threshold range, and calculating a classification similarity between a classification result of the classification model with respect to the respective training sample and a classification result of the classification model with respect to the determined respective target sample; and
determining, based on classification similarities between classification results of respective training samples in the training data set and classification results of corresponding target samples in the target data set, classification robustness of the classification model with respect to the target data set.

2. The robustness estimation method according to claim 1, further comprising:
determining a classification confidence of the classification model with respect to each training sample, based on the classification result of the classification model with respect to the respective training sample and a true category of the respective training sample,
wherein the classification robustness of the classification model with respect to the target data set is determined based on the classification similarities between the classification results of respective training samples in the training data set and the classification results of corresponding target samples in the target data set, and the classification confidence of the classification model with respect to the respective training samples.

3. The robustness estimation method according to claim 1, further comprising:
obtaining a first subset and a second subset with equal numbers of samples by randomly dividing the training data set;
for each training sample in the first subset, determining a respective training sample in the second subset that has a similarity with the training sample that is within a predetermined threshold range, and calculating a classification similarity between a classification result of the classification model with respect to the respective training sample in the first subset and a classification result of the classification model with respect to the determined respective training sample in the second subset;
determining, based on classification similarities between classification results of respective training samples in the first subset and classification results of corresponding training samples in the second subset, reference robustness of the classification model with respect to the training data set; and
determining, based on the classification robustness of the classification model with respect to the target data set and the reference robustness of the classification model with respect to the training data set, relative robustness of the classification model with respect to the target data set.

4. The robustness estimation method according to claim 1, wherein in the determining of the respective target sample that has the sample similarity, a similarity threshold associated with a category to which the respective training sample belongs is taken as the predetermined threshold.

5. The robustness estimation method according to claim 4, wherein the similarity threshold associated with the category to which the respective training sample belongs comprises: an average sample similarity among training samples that belong to the category in the training data set.

6. The robustness estimation method according to claim 1, wherein in the determining of the respective target sample, feature similarities between a feature extracted with the classification model from the respective training sample and features extracted with the classification model from respective target samples in the target data set are taken as sample similarities between the respective training sample and the respective target samples.

7. The robustness estimation method according to claim 1, wherein both the training data set and the target data set comprise image data samples or time-series data samples.

8. A data processing method, comprising:
inputting a target sample into a classification model, the classification model being obtained in advance through training with a training data set, and
classifying the target sample with the classification model,
wherein classification robustness of the classification model with respect to a target data set to which the target sample belongs exceeds a predetermined robustness threshold, the classification robustness being estimated by the robustness estimation method according to claim 1.

9. The data processing method according to claim 8, wherein
the classification model comprises one of: an image classification model for semantic segmentation, an image classification model for handwritten character recognition, an image classification model for traffic sign recognition, and a time-series data classification model for weather forecast.

10. An information processing apparatus, comprising:
a processor configured to:
for each training sample in a training data set, determine a respective target sample in a target data set that has a sample similarity with a respective training sample that is within a predetermined threshold range, and calculate a classification similarity between a classification result of a classification model with respect to the respective training sample and a classification result of the classification model with respect to the determined respective target sample, wherein the classification model is obtained in advance through training based on the training data set; and
determine, based on classification similarities between classification results of respective training samples in the training data set and classification results of corresponding target samples in the target data set, classification robustness of the classification model with respect to the target data set.

11. The information processing apparatus according to claim 10, wherein the processor is further configured to:
determine a classification confidence of the classification model with respect to each training sample, based on the classification result of the classification model with respect to the respective training sample and a true category of the respective training sample,
wherein the classification robustness of the classification model with respect to the target data set is determined based on the classification similarities between the classification results of respective training samples in the training data set and the classification results of corresponding target samples in the target data set, and the classification confidence of the classification model with respect to the respective training samples.

12. The information processing apparatus according to claim 10, wherein the processor is further configured to:
obtain a first subset and a second subset with equal numbers of samples by randomly dividing the training data set;
for each training sample in the first subset, determine a training sample in the second subset that has a similarity with the training sample that is within a predetermined threshold range, and calculate a sample similarity between a classification result of the classification model with respect to the training sample in the first subset and a classification result of the classification model with respect to the determined training sample in the second subset;
determine, based on classification similarities between classification results of respective training samples in the first subset and classification results of corresponding training samples in the second subset, reference robustness of the classification model with respect to the training data set; and
determine, based on the classification robustness of the classification model with respect to the target data set and the reference robustness of the classification model with respect to the training data set, relative robustness of the classification model with respect to the target data set.

13. The information processing apparatus according to claim 10, wherein the processor is further configured to, in the determining of the respective target sample that has the sample similarity, use a similarity threshold associated with a category to which the respective training sample belongs as the predetermined threshold.

14. The information processing apparatus according to claim 13, wherein the similarity threshold associated with the category to which the respective training sample belongs includes: an average sample similarity among training samples that belong to the category in the training data set.

15. The information processing apparatus according to claim 10, wherein the processor is further configured to, in the determining of the respective target sample, take feature similarities between a feature extracted with the classification model from the respective training sample and features extracted with the classification model from respective target samples in the target data set as sample similarities between the respective training sample and the respective target samples.

16. The information processing apparatus according to claim 10, wherein both the training data set and the target data set comprise image data samples or time-series data samples.

17. A machine-readable storage medium having stored instructions therein, wherein the instructions, when being read and executed by a machine, cause the machine to execute a robustness estimation method, the robustness estimation method includes:
for each training sample in the training data set, determining a respective target sample in a target data set that has a sample similarity with a respective training sample is within a predetermined threshold range, and calculating a classification similarity between a classification result of the classification model with respect to the respective training sample and a classification result of the classification model with respect to the determined respective target sample, wherein the classification model is obtained in advance through training based on the training data set; and
determining, based on classification similarities between classification results of respective training samples in the training data set and classification results of corresponding target samples in the target data set, classification robustness of the classification model with respect to the target data set.
